(19) United States
(12) Patent Application Publication
(10) Pub. No.: US 2025/0381791 A1
(43) Pub. Date: Dec. 18, 2025

(54) LIQUID EJECTION APPARATUS AND CONTROL METHOD OF THE SAME

(71) Applicant: CANON KABUSHIKI KAISHA, Tokyo (JP)

(72) Inventors: TAKAYUKI USHIYAMA, Chiba (JP); TAKESHI YAZAWA, Kanagawa (JP); HIDEHIKO KANDA, Kanagawa (JP); YUJI KONNO, Kanagawa (JP); TAICHI YOKOKAWA, Kanagawa (JP); MASAKI NITTA, Kanagawa (JP); JUMPEI JOGO, Tokyo (JP)

(21) Appl. No.: 19/226,269

(22) Filed: Jun. 3, 2025

(30) Foreign Application Priority Data
Jun. 18, 2024 (JP) 2024-098191

(51) Int. Cl. B41J 29/393; B41J 11/00; B41J 25/00

(52) U.S. Cl. CPC B41J 29/393; B41J 11/002; B41J 25/001

(57) ABSTRACT

A liquid ejection apparatus includes a scanning unit to cause a liquid ejection head to perform forward and backward scans in a scanning direction, a conveyance unit to convey a print medium in a conveyance direction, and a control unit to cause the scanning unit to wait for a first waiting time at a first waiting position between the end of a backward scan and the start of a forward scan, and wait for a second waiting time at a second waiting position between the end of a forward scan and the start of a backward scan. The control unit sets the second waiting time to a first value if the first waiting time is the first value, and sets the second waiting time to be shorter than the first waiting time if the first waiting time is a second value larger than the first value.

### BACKGROUND

### Field of the Technology

The present disclosure relates to a liquid ejection apparatus and a control method of the same.

### Description of the Related Art

In some liquid ejection apparatus that performs printing by ejecting liquids from nozzles onto a print medium, a carriage waiting time is provided during a printing operation to allocate a time for fixing the liquids applied on the print medium.

Japanese Patent Laid-Open No. 2022-65753 discloses a printing apparatus (liquid ejection apparatus) in which a predetermined wait time (waiting time) of a carriage equipped with a liquid ejection head can be provided before the start of a main scan (start of a forward scan) and before the start of a reverse scan (start of a backward scan). In the liquid ejection head of Japanese Patent Laid-Open No. 2022-65753, the carriage waits on a home position (HP) side before the start of the forward scan and waits on a back position (BP) side before the start of the backward scan. According to the liquid ejection apparatus of Japanese Patent Laid-Open No. 2022-65753, the waiting time of the carriage is provided before the start of the main scan and before the start of the reverse scan, so that the time for fixing the liquids applied on the print medium is allocated.

### SUMMARY

While the carriage is waiting, the liquids are preliminarily ejected in order to keep the nozzle surface from drying out in some cases. However, to avoid a size increase of the apparatus, a maintenance mechanism capable of receiving the preliminarily ejected liquids is often provided only on the HP side and not on the BP side. In this case, in the liquid ejection apparatus of Japanese Patent Laid-Open No. 2022-65753, the nozzle surface may dry out if the liquid fixing time is allocated by causing the carriage to wait on the BP side where preliminary ejection is not possible.

Therefore, the present disclosure has an object to provide a liquid ejection apparatus capable of allocating a liquid fixing time.

A liquid ejection apparatus according to the present disclosure includes: a scanning unit configured to cause a liquid ejection head to perform forward and backward scans in a scanning direction, the liquid ejection head configured to perform an ejection operation by ejecting a liquid; a conveyance unit configured to convey a print medium in a conveyance direction crossing the scanning direction; and a control unit configured to cause the scanning unit to wait for a first waiting time at a first waiting position after the end of a backward scan and before the start of a forward scan of the scanning unit, and cause the scanning unit to wait for a second waiting time at a second waiting position after the end of a forward scan and before the start of a backward scan of the scanning unit, wherein the control unit performs control to set the second waiting time to a first value in a case where the first waiting time is the first value, and set the second waiting time to be shorter than the first waiting time in a case where the first waiting time is a second value that is larger than the first value.

Features of the present disclosure will become apparent from the following description of embodiments with reference to the attached drawings. The following description of embodiments are described by way of example.

### BRIEF DESCRIPTION OF THE DRAWINGS

FIG. 1 is a view illustrating an example of an external appearance of a liquid ejection apparatus in an embodiment;

FIG. 2 is a schematic cross-sectional view of a liquid ejection apparatus in an embodiment;

FIG. 3 is a view illustrating an example of a nozzle surface in an embodiment;

FIG. 4 is a block diagram illustrating an example of a schematic structure of a control system in an embodiment;

FIG. 5 is a diagram for explaining a multipass printing method in an embodiment;

FIG. 6 is a diagram illustrating an example of mask patterns;

FIG. 7A is a schematic diagram of printing operations performed on a first area at which a first pass is performed with a forward scan;

FIG. 7B is a schematic diagram of printing operations on a second area at which a first pass is performed with a backward scan;

FIG. 8 is a diagram illustrating an example of a table indicating pass time intervals in multipass printing;

FIG. 9 is a diagram illustrating an example of a table that can be stored in a memory in an embodiment;

FIG. 10 is a flowchart presenting processes in an embodiment;

FIG. 11 is a diagram illustrating an example of a table stored in a memory in an embodiment; and

FIG. 12 is a diagram illustrating an example of a table stored in a memory in an embodiment.

### DESCRIPTION OF THE EMBODIMENTS

In the present disclosure, “printing” means not only to form meaningful information (for example, such as characters and graphics which are noticeable to such a degree that humans can perceive them visually), but also to form meaningless information. In addition, in the present disclosure, “printing” broadly means to form an image, a design, a pattern, a structure, a combination of these, or the like on a print medium or to process a medium.

“Print media” include not only paper for use in general printing apparatuses, but also any media capable of receiving inks, such as cloth, plastic film, metallic plate, glass, ceramic, resin, wood, and leather. The print medium may be any medium on which an image can be formed with liquid droplets applied. For example, print media made of various materials in various forms, such as paper, cloth, optical disk label surface, plastic sheet, OHP sheet, and envelop, may be used.

### First Embodiment

### (1) Configuration of Liquid Ejection Apparatus 100

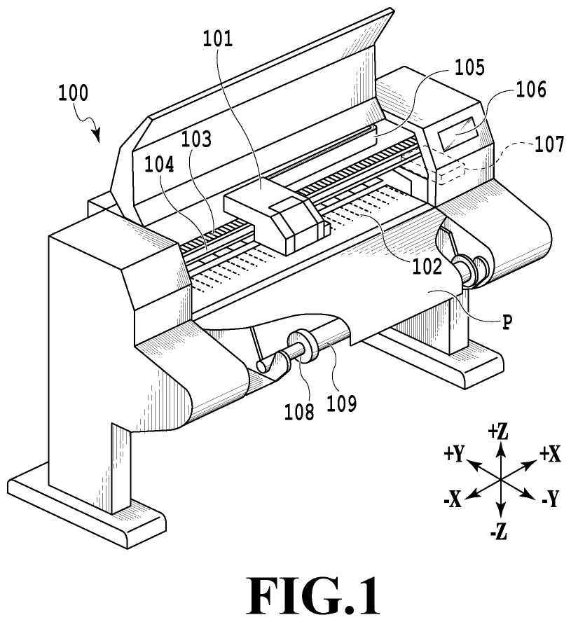

FIG. 1 is a view illustrating an external appearance of a liquid ejection apparatus 100 applicable in the present embodiment.

As illustrated in FIG. 1, in the present embodiment, a so-called serial-type inkjet printing apparatus is used as the liquid ejection apparatus 100. The liquid ejection apparatus 100 includes a carriage unit 101 configured to perform forward and backward scans in a scanning direction (X direction), and a platen 102 configured to support a print medium P. The liquid ejection apparatus 100 includes an encoder 103 configured to detect the position of the carriage unit 101, a guide shaft 104 configured to support the carriage unit 101, and a flexible printed circuit board 105 having flexibility.

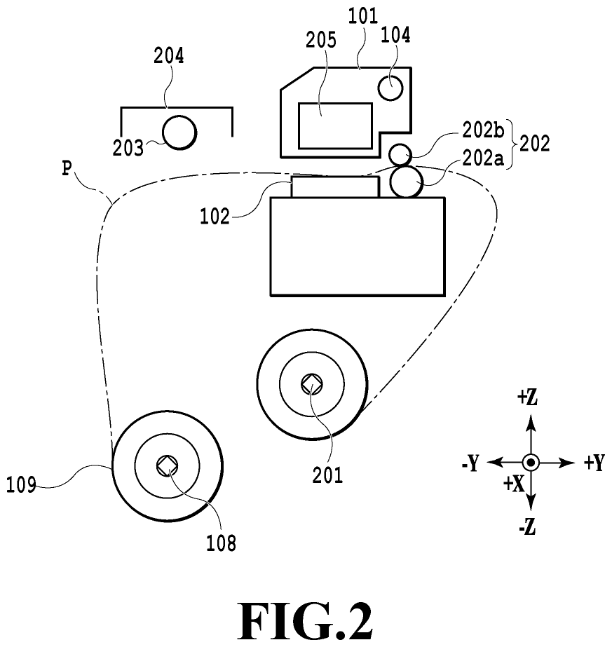

The liquid ejection apparatus 100 includes a user interface (UI) screen 106 on which instructions related to printing can be inputted and outputted, and a maintenance mechanism 107 configured to maintain the performance of the carriage unit 101. The maintenance mechanism 107 includes a cap unit for receiving preliminary ejection from a liquid ejection head 205 (see FIG. 2) and for capping a nozzle surface, and a suction mechanism (for example, a pump) for forcibly sucking liquids while the nozzle surface is capped. The maintenance mechanism 107 may include a cleaning blade for wiping off smears from the nozzle surface.

Hereinafter, a position where the maintenance mechanism 107 is installed in a scanning area where the carriage unit 101 can perform scans in the X direction will be referred to as a home position (HP) side. On the other hand, a position which is far from the maintenance mechanism 107 and at which the carriage unit 101 can wait will be referred to as a back position (BP) side. The liquid ejection apparatus 100 includes a winder spool 108 configured to wind the print medium P. The print medium P is wound by the winder spool 108. As a result, a roll of a wound medium 109 is formed.

FIG. 2 is a schematic cross-sectional view of the liquid ejection apparatus 100 applicable to the present embodiment.

As illustrated in FIG. 2, the liquid ejection apparatus 100 includes a holder spool 201 configured to hold the print medium P, a conveyance roller pair 202 configured to convey the print medium P, a heater 203 configured to fix the liquids applied to the print medium P, and a cover 204 configured to cover the heater 203. The conveyance roller pair 202 includes a conveyance roller 202a and a pinch roller 202b. The carriage unit 101 includes the liquid ejection head 205 configured to eject the liquids.

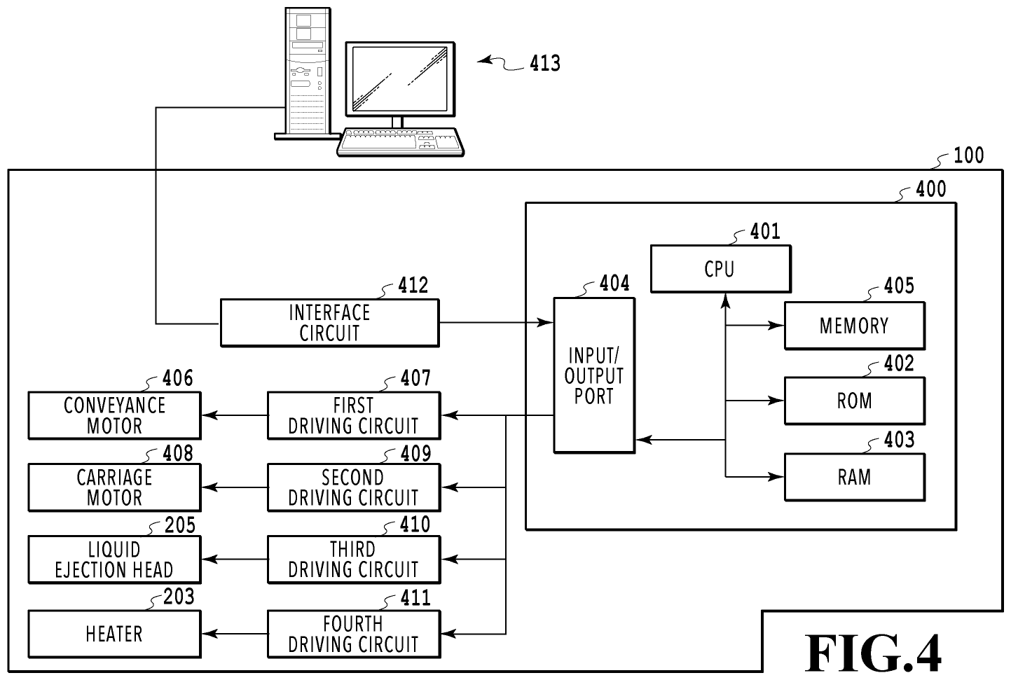

In operations for printing (printing operations) in the present embodiment, the liquid ejection head 205 performs scans in the scanning direction (X direction in the drawings) crossing a conveyance direction (−Y direction in the drawings) of the print medium P. During the scans, the liquids (for example, inks) are applied to the print medium P, so that an image is printed. The conveyance roller pair 202 driven via a gear by a conveyance motor 406 (see FIG. 4) conveys the print medium P in the −Y direction from the holder spool 201 holding the print medium P. On the other hand, at a predetermined conveyance position, the carriage unit 101 is driven by a carriage motor 408 (see FIG. 4) to perform forward and backward scans (reciprocating movements) along the guide shaft 104 extending in the X direction.

In the course of these scans, ejection operations of ejecting the inks from nozzles of the liquid ejection head 205 detachably attached to the carriage unit 101 are performed at timing based on position signals obtained from the encoder 103 (see FIG. 1). Thus, a certain band width corresponding to a range of nozzle arrays can be printed. The configuration of the liquid ejection head 205 will be described later. In the present embodiment, the ejection operations are performed at a scanning speed of 30 inches per second with a printing resolution of 1200 dpi (at intervals of 1/1200 inches). In the present specification, hereinafter, the scans of the carriage unit 101 associated with the above ejection operations of the liquid ejection head 205 will be simply referred to as “scans”. After one scan is completed, the print medium P is conveyed in the −Y direction by a distance corresponding to one band, and printing is performed for the next band width.

After that, the scans and the conveyance operations are alternately repeated, so that an image is printed sequentially on the print medium P.

Here, a carriage belt (not illustrated) is used to transmit the driving force of the carriage motor 408 to the carriage unit 101. Instead of the carriage belt, another driving method may be used such, for example, as a unit including a lead screw extended in the X direction and configured to be rotationally driven by the carriage motor 408 and an engagement portion provided to the carriage unit 101 and engaging with a groove of the lead screw.

The conveyed print medium P is held and conveyed between the conveyance roller pair 202, and is guided to a print position on the platen 102, in other words, the scanning area of the liquid ejection head 205. In general, in the state of rest, the nozzle surface of the liquid ejection head 205 is capped at the home position. Therefore, at the start of a printing operation, the nozzle surface is uncapped before the printing and the carriage unit 101 is made ready for scans. Then, once data for one scan of the carriage unit 101 is stored in a buffer, the carriage unit 101 is driven by the carriage motor 408 to perform the scan, so that the printing operation is performed. The print medium P on which the image is formed by the liquid ejection head 205 is wound by the winder spool 108 and the roll of the wound medium 109 is formed.

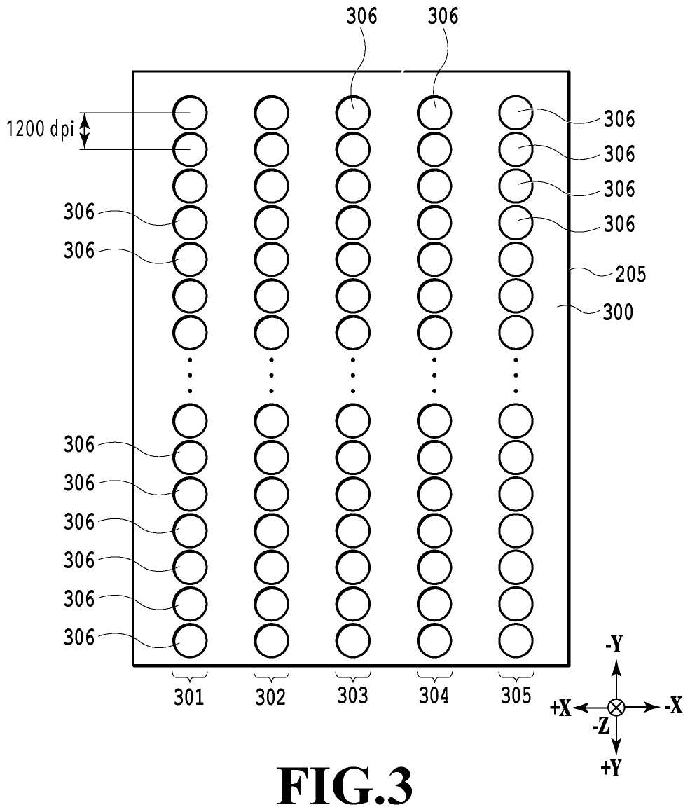

To the liquid ejection head 205, the flexible printed circuit board 105 (see FIG. 1) is attached for supplying driving pulses for the ejection operations, signals for head temperature adjustment, and the like. The other end of the flexible printed circuit board 105 is connected to a controller 400 (see FIG. 3) including a CPU 401 (see FIG. 3) configured to control the liquid ejection apparatus 100. The UI screen 106 (see FIG. 1) is configured to allow a user to input instructions to start and stop printing operations, and to confirm information about the print medium P and the like.

The heater 203 is located downstream, in the conveyance direction, of a position where the liquid ejection head 205 mounted on the carriage unit 101 performs forward and backward scans in the scanning direction. The heater 203 is supported by a frame not illustrated, and applies heat to the inks in the liquid state applied to the print medium P to dry the inks. As the heater 203, a sheath heater, a halogen heater, or the like is used. The heater 203 is covered with the cover 204. The cover 204 has a function of efficiently irradiating the print medium P with the heat of the heater 203 and a function of protecting the heater 203.

The heating temperature of the heater 203 is set with the film-forming performance and productivity of water-soluble resin fine particles and the heat resistance of the print medium P taken into consideration. Examples of a method of heating the print medium P include a method of blowing hot air to the print medium P from above and a method of heating the print medium P from below using a contact-type heat conduction heater. In the present embodiment, one heater 203 is used. Instead, two or more heaters 203 may be used in combination as long as the temperature on the print medium P measured by a radiation thermometer (not illustrated) will not exceed the set value of the heating temperature.

The maintenance mechanism 107 (see FIG. 1) performs a suction process and a wiping process on the liquid ejection head 205, and also has a function of receiving droplets (for example, ink droplets) ejected in the preliminary ejection performed by the liquid ejection head 205.

The printing apparatus of the present embodiment performs so-called multipass printing in which the liquid ejection head 205 performs multiple scans (n scans) to form an image on a predetermined area (area of 1/n band) of the print medium P. Here, the above “n” is an integer of 2 or more. The multipass printing will be described later.

### (2) Configuration of Liquid Ejection Head 205

FIG. 3 is a view illustrating a nozzle surface 300 of the liquid ejection head 205 applicable to the present embodiment.

As illustrated in FIG. 3, the nozzle surface 300 includes a first nozzle array 301 for ejecting a black ink (K) as a liquid (ink containing a colorant). The nozzle surface 300 includes a second nozzle array 302 for ejecting a cyan ink (C) as a liquid. The nozzle surface 300 includes a third nozzle array 303 for ejecting a magenta ink (M) as a liquid. The nozzle surface 300 includes a fourth nozzle array 304 for ejecting a yellow ink (Y) as a liquid. Since these inks contain colorants, they will be also referred to as colorant inks or color inks below.

The liquid ejection head 205 also includes a fifth nozzle array 305 for ejecting a reactive liquid ink (RCT) not containing a colorant. The reactive liquid ink does not contain a colorant, but contains a reactive ingredient that reacts with the colorants contained in the colorant inks, and reacts with the colorant inks upon contact with them on the print medium P (see FIG. 1 and so on), thereby suppressing blur and bleeding of the colorant inks. In the present disclosure, it is not essential to prepare the reactive liquid ink (RCT).

In the nozzle surface 300, the first nozzle array 301, the second nozzle array 302, the third nozzle array 303, the fourth nozzle array 304, and the fifth nozzle array 305 are arranged in this order from the left side to the right side in FIG. 3. In each of these five types of nozzle arrays, 1280 nozzles 306 for ejecting the ink are arranged along the Y direction (array direction) at a density of 1200 dpi. In the present embodiment, a volume of ink droplet (ejection volume) ejected from each nozzle 306 is about 4.5 pl.

These five types of nozzle arrays are individually connected to five types of ink tanks (not illustrated) that store the inks dedicated to the respective nozzle arrays. The inks are supplied from the five types of ink tanks to the five types of nozzle arrays, respectively. The liquid ejection head 205 and the ink tanks may be configured as an integrated component or as separable components. Instead of or in addition to the reactive liquid ink, each of the five types of colorant inks described above may contain water-soluble resin fine particles that form a film under heating and improve the scratch resistance of an image printed on the print medium P.

### (3) Configuration of Printing System

FIG. 4 is a block diagram illustrating a schematic configuration of a control system of the liquid ejection apparatus 100 in the present embodiment.

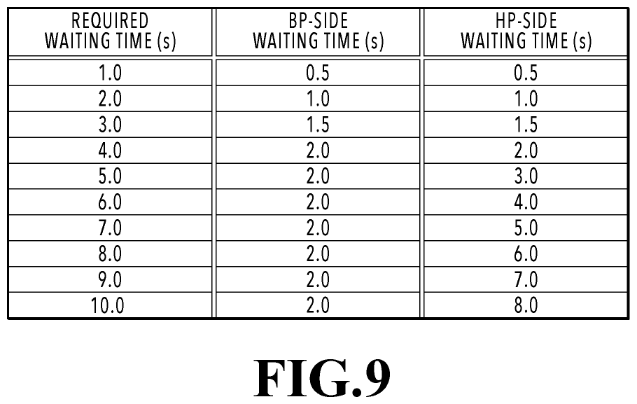

As illustrated in FIG. 4, the controller 400 includes the CPU 401, a ROM 402 for storing a control program to be executed by the CPU 401 and others, a RAM 403 used as a buffer for print data, an input/output port 404, and so on. The CPU 401 executes processing operations such as calculation, selection, discrimination, and control, as well as printing operations. A memory 405 stores data to be described later, such as mask patterns and tables (see FIG. 9 and others) in which waiting times of the carriage unit 101 (see FIG. 1) are set.

A first driving circuit 407 for driving the conveyance motor 406 is connected to the input/output port 404. A second driving circuit 409 for driving the carriage motor 408 is connected to the input/output port 404. A third driving circuit 410 for driving the liquid ejection head 205 is connected to the input/output port 404. A fourth driving circuit 411 for driving the heater 203, an actuator in a cutting unit, and so on is connected to the input/output port 404.

The controller 400 is connected to a host apparatus 413 via an interface circuit 412.

### (4) Multipass Printing Method

In the present embodiment, by use of the five types of inks described above, an image is formed in a so-called bidirectional multipass printing method in which an image on a predetermined area of the print medium P is formed with multiple forward and backward scans (also called passes). Hereinafter, this bidirectional multipass printing method (simply referred to as the multipass printing below) will be described.

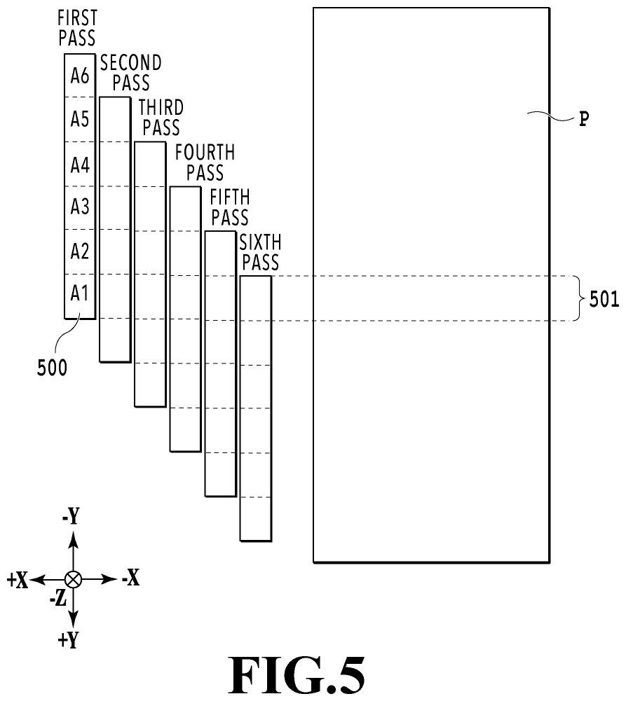

FIG. 5 is a diagram for explaining the multipass printing method applicable to the present embodiment.

In FIG. 5, description will be given of a case where each of six nozzle groups A1 to A6 into which each of the five types of nozzle arrays described above is divided in the Y direction ejects the ink in the corresponding one of six scans for a predetermined area. In the following description, the five types of nozzle arrays described above will be simply referred to as a nozzle array 500 because there is no need to distinguish among the first to fifth nozzle arrays 301 to 305 (see FIG. 3) in particular. While the liquid ejection head 205 performs scans, the print medium P is actually conveyed in the −Y direction. However, for convenience of description, the description in FIG. 5 is given by using a diagram in which the liquid ejection head 205 is moved in the +Y direction with respect to a predetermined area 501 of the print medium P.

First, in the first scan (first pass), the liquid ejection head 205 performs the scan with a positional relationship in which the nozzle group A1 faces the predetermined area 501 on the print medium P. The nozzle group A1 ejects the inks onto the predetermined area 501 according to print data allocated to the first scan for all the types of inks. After this first pass is completed, the print medium P is conveyed in the −Y direction by a distance corresponding to one nozzle group.

Then, a second scan (second pass) is performed and the inks are ejected onto the predetermined area 501 by using the nozzle group A2. After that, the conveyance of the print medium P and the ink ejection from the liquid ejection head 205 are alternately performed, so that the ejection from the nozzle groups A3 to A6 is executed in the third to sixth scans on the predetermined area 501. In this way, the multipass printing on the predetermined area 501 is completed.

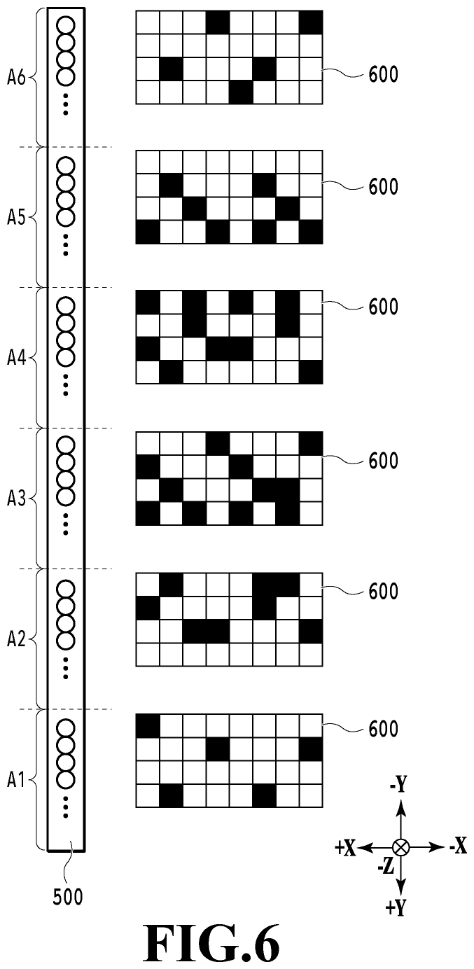

FIG. 6 is a diagram illustrating an example of mask patterns 600.

In the mask patterns 600 illustrated in FIG. 6, each blackened section represents a pixel in which ink ejection is permitted if the ink ejection is determined in quantized data. Hereinafter, the blackened pixel will be also referred to as a “print-permitted pixel”.

In the mask patterns 600 illustrated in FIG. 6, each white section represents a pixel in which ink ejection is not permitted even if the ink ejection is determined in the quantized data. Hereinafter, the white pixel will be also referred to as a “print-unpermitted pixel”.

FIG. 6 presents six types of mask patterns 600 each having a size of 4×8 pixels. Processing of allocating all the quantized data for all the predetermined areas is performed by repeatedly applying each of these six mask patterns 600 in the X direction and the Y direction.

The number of pixels present in each of the six mask patterns 600 in FIG. 6 is 32 pixels (=4×8 pixels), and the total of print-permitted pixels in the six mask patterns 600 is 48 pixels. Here, a ratio of the number of print-permitted pixels to the number of pixels in the mask patterns 600 is referred to as a print permission rate. In this case, the print permission rate of the total of the mask patterns 600 in FIG. 6 is 150% (=48/32×100).

Here, the mask patterns 600 for respective scans are described. The mask pattern 600 for the first scan (nozzle group A1) and the mask pattern 600 for the sixth scan (nozzle group A6) each have five print-permitted pixels arranged therein. Accordingly, the print permission rate of the mask pattern for each of the first and sixth scans is about 15% (= 5/32×100).

The mask pattern 600 for the second scan (nozzle group A2) and the mask pattern 600 for the fifth scan (nozzle group A5) each have eight print-permitted pixels arranged therein. Accordingly, the print permission rate of the mask pattern for each of the second and fifth scans is about 25% (= 8/32×100).

The mask pattern 600 for the third scan (nozzle group A3) and the mask pattern 600 for the fourth scan (nozzle group A4) each have eleven print-permitted pixels arranged therein. Accordingly, the print permission rate of the mask pattern for each of the third and fourth scans is about 34% (= 11/32×100). In other words, in the case where the mask patterns 600 as illustrated in FIG. 6 are used, the third and fourth passes have the greatest volume of the inks ejected among the first to sixth passes. On the other hand, the first and sixth passes have the smallest volume of the inks ejected.

### (5) Ink Compositions

### (Outline of Ink Compositions)

Details of each of the inks constituting an ink set used in the present embodiment will be described. Hereinafter, “parts” and “%” are based on mass unless otherwise specified.

### (5-1) Compositions of Inks

Hereinafter, the composition of each of the inks will be described in detail.

All of the colorant inks (C, M, Y, K) and the reactive liquid ink (RCT) used in the present embodiment contain a water-soluble organic solvent. The water-soluble organic solvent preferably has a boiling point of 150° C. or more and 300° C. or less from the viewpoints of the wettability and moisture retention of the nozzle surface 300 (see FIG. 3).

The water-soluble organic solvent is particularly preferably a ketone-based compound, an ethylene glycol derivative, a heterocyclic compound, or the like from the viewpoints of a function as a film-forming aid for resin fine particles and the swelling/solubility properties of the print medium P on which the resin layer is formed. Examples of the ketone-based compound include acetone, cyclohexanone, and the like. Examples of the ethylene glycol derivative include tetraethylene glycol dimethyl ether and the like. The heterocyclic compound has a lactam structure typified by N-methyl-pyrrolidone and 2-pyrrolidone.

From the viewpoint of ejection performance, the content of the water-soluble organic solvent is preferably 3 wt % or more and 30 wt % or less. Specific examples of the water-soluble organic solvent include methyl alcohol, ethyl alcohol, n-propyl alcohol, isopropyl alcohol, n-butyl alcohol, and sec-butyl alcohol. Another specific example of the water-soluble organic solvent is alkyl alcohol having 1 to 4 carbon atoms such as tert-butyl alcohol. Other specific examples of the water-soluble organic solvent include amides such as dimethylformamide and dimethylacetamide.

Other specific examples of the water-soluble organic solvent include ketones and keto alcohols such as acetone and diacetone alcohol. Other specific examples of the water-soluble organic solvent include ethers such as tetrahydrofuran and dioxane. Other specific examples of the water-soluble organic solvent include polyalkylene glycols such as polyethylene glycol and polypropylene glycol. Another specific example of the water-soluble organic solvent is ethylene glycol.

Other specific examples of the water-soluble organic solvent include propylene glycol, butylene glycol, triethylene glycol, 1,2,6-hexanetriol, thiodiglycol, and hexylene glycol. Other specific examples of the water-soluble organic solvent include alkylene glycols in which an alkylene group has 2 to 6 carbon atoms, such as diethylene glycol. Other specific examples of the water-soluble organic solvent include lower alkyl ether acetates such as polyethylene glycol monomethyl ether acetate.

Another specific example of the water-soluble organic solvent is glycerin. Other specific examples of the water-soluble organic solvent include ethylene glycol monomethyl (or ethyl) ether and diethylene glycol methyl (or ethyl) ether. Other specific examples of the water-soluble organic solvent include lower alkyl ethers of polyhydric alcohols such as triethylene glycol monomethyl (or ethyl) ether.

Other specific examples of the water-soluble organic solvent include polyhydric alcohols such as trimethylolpropane and trimethylolethane. Other specific examples of the water-soluble organic solvent include N-methyl-2-pyrrolidone, 2-pyrrolidone, 1,3-dimethyl-2-imidazolidinone, and the like. The aforementioned water-soluble organic solvents may be each used alone or may be used as a mixture.

In addition, it is preferable to use deionized water as water. The content of the water-soluble organic solvent in the reactive liquid ink (RCT) is not particularly limited. In addition to the above-mentioned ingredient, a surfactant, a defoamer, a preservative, an antifungal agent, and the like may be added as appropriate to each of the colorant inks (C, M, Y, K) in order to impart desired physical properties as needed.

All of the colorant inks (C, M, Y, K) and the reactive liquid ink (RCT) used in the present embodiment contain a surfactant. The surfactant is used as a penetrant to improve the ink's penetration power into print media P dedicated for inkjet printing. As the amount of the surfactant added increases, the surfactant exerts a stronger ability to lower the surface tension of the ink, thereby improving the ink's wetting power and penetration power to the print media P.

In the present embodiment, each of the inks was adjusted with addition of a small amount of acetylene glycol EO adduct or the like as the surfactant so that the surface tension of each of the inks was 30 dyn/cm or less and the difference in surface tension among the inks was 2 dyn/cm or less. More specifically, each of the inks was adjusted to have a surface tension of about 22 to 24 dyn/cm. The surface tension was measured by using a fully-automatic surface tensiometer CBVP-Z (manufactured by Kyowa Interface Science Co., Ltd.). A measurement device is not limited to the above example, as long as the surface tensions of the inks can be measured.

In the present embodiment, the pH value of each of the inks is stable on an alkali side with the value ranging from 8.5 to 9.5. The pH value of each of the inks is preferably 7.0 or more and 10.0 or less in order to prevent elution or performance deterioration of members to come into contact with the inks in the liquid ejection apparatus 100 and the liquid ejection head 205 and to prevent a decrease in the solubility of dispersed resins in the inks and the like. The pH value was measured by using a pH meter of a model F-52 (manufactured by Horiba Ltd.). A measurement device is not limited to the above example, as long as the pH values of the inks can be measured.

### (5-2) Reactive Liquid

In the present embodiment, the reactive liquid for insolubilizing a part or all of the solid ingredients of the colorant inks is used in order to suppress bleeding, beading, and the like.

An example of the reactive liquid capable of insolubilizing dissolved dyes or dispersed pigments and resins is a solution containing polyvalent metal ions. For example, this solution contains magnesium nitrate, magnesium chloride, aluminum sulfate, iron chloride, or the like. As one type of flocculation action using such cations, a low molecular weight cationic polymer flocculant can be used for the purposes of neutralizing the charge of water-soluble resin fine particles and insolubilizing an anionic soluble substance.

Another reactive system is an insolubilization system with a reactive liquid utilizing a difference in pH value. As mentioned above, the colorant inks used in ink-jet printing generally tend to be stable on the alkaline side due to their nature. The specific pH value is often about 7 to 10. The pH value is often set to about 8.5 to 9.5 with the general industrial viewpoint, the influence on an external environment, and others taken into account. In order to flocculate and solidify such colorant inks, an acidic solution is mixed to change their pH values, thereby destroying the stable state and flocculating dispersed ingredients. For the purpose of obtaining such action, an acidic solution may be also used as the reactive liquid.

### (5-3) Water-Soluble Resin Fine Particles

The colorant inks used in the present embodiment contain water-soluble resin fine particles. The “water-soluble resin fine particles” mean polymer fine particles present in a dispersed state in water.

Specific examples of the water-soluble resin fine particles include acrylic resin fine particles synthesized by emulsion polymerization or the like of monomers such as (meth)acrylic acid alkyl ester and (meth)acrylic acid alkyl amide; and (meth)acrylic acid alkyl ester. Another specific example of the water-soluble resin fine particles is styrene-acrylic resin fine particles synthesized by emulsion polymerization or the like of styrene monomers and (meth)acrylic acid alkyl amide or the like. Other specific examples of the water-soluble resin fine particles include polyethylene resin fine particles, polypropylene resin fine particles, polyurethane resin fine particles, styrene-butadiene resin fine particles, and the like.

As the water-soluble resin fine particles, core-shell type resin fine particles may be used in which the core and the shell constituting a resin fine particle have different polymer compositions. Furthermore, as the water-soluble resin fine particles, resin fine particles may be used which are obtained by emulsion polymerization around previously synthesized acrylic fine particles, which are used as seed particles in order to control the particle size. Moreover, as the water-soluble resin fine particles, hybrid-type resin fine particles in which different resin fine particles such as acrylic resin fine particles and urethane resin fine particles are chemically bonded or the like may be used.

### (Composition of Each Ink)

The inks constituting the ink set used in the present embodiment will be described in detail. Hereinafter, “parts” and “%” are based on mass unless otherwise specified.

### 1. Black Ink

### (1) Dispersion Preparation

First, an anionic polymer P-1 [styrene/butyl acrylate/acrylic acid copolymer (polymerization ratio (weight ratio)=30/40/30), an acid value of 202, and a weight average molecular weight of 6500] was prepared. This was neutralized with an aqueous solution of potassium hydroxide, and the resultant was diluted with ion-exchanged water to prepare a homogeneous 10% by mass water-soluble resin fine particle dispersion.

Then, 600 g of the above polymer solution, 100 g of carbon black, and 300 g of ion-exchanged water were mixed and mechanically stirred for a predetermined time. After that, the mixture was centrifuged to remove undispersed substances including coarse particles, to obtain a black dispersion. In the obtained black dispersion, the pigment concentration was 10% by mass.

### (2) Ink Preparation

In the ink preparation, the above black dispersion was used and adjusted to a predetermined concentration with addition of the following ingredients thereto. These ingredients were thoroughly mixed and stirred, and then were filtered under pressure through a microfilter with a pore size of 2.5 μm (manufactured by FUJIFILM Corporation) to prepare a pigment ink with a pigment concentration of 2% by mass.

| | | |
|---|---|---|
| Above black dispersion | 20 | parts |
| Above water-soluble resin fine | 40 | parts |
| particle dispersion | | |
| Zonyl FSO-100 (fluorosurfactant | 0.05 | parts |
| manufactured by DuPont) | | |
| 2-Methyl-1,3-propanediol | 15 | parts |
| 2-Pyrrolidone | 5 | parts |
| Acetylene glycol EO adduct (manufactured | 0.5 | parts |

| | |
|---|---|
| by Kawaken Fine Chemicals Co., Ltd.) | |
| Ion-exchanged water | Balance |

### 2. Cyan Ink

### (1) Dispersion Preparation

First, an AB-type block polymer with an acid value of 250 and a number average molecular weight of 3000 was prepared by a usual method using benzyl acrylate and methacrylic acid as raw materials, and then neutralized with an aqueous solution of potassium hydroxide. The resultant was diluted with ion-exchanged water to prepare a homogeneous 50% by mass water-soluble resin fine particle dispersion.

Then, 200 g of the above polymer solution, 100 g of C.I. Pigment Blue 15:3, and 700 g of ion-exchanged water were mixed and mechanically stirred for a predetermined time. After that, the mixture was centrifuged to remove undispersed substances including coarse particles, to obtain a cyan dispersion. In the obtained cyan dispersion, the pigment concentration was 10% by mass.

### (2) Ink Preparation

In the ink preparation, the above cyan dispersion was used and adjusted to a predetermined concentration with addition of the following ingredients thereto. These ingredients were thoroughly mixed and stirred, and then were filtered under pressure through a microfilter with a pore size of 2.5 μm (manufactured by FUJIFILM Corporation) to prepare a pigment ink with a pigment concentration of 2% by mass.

| | | |
|---|---|---|
| Above cyan dispersion | 20 | parts |
| Above water-soluble resin fine | 40 | parts |
| particle dispersion | | |
| Zonyl FSO-100 (fluorosurfactant | 0.05 | parts |
| manufactured by DuPont) | | |
| 2-Methyl 1,3-propanediol | 15 | parts |
| 2-Pyrrolidone | 5 | parts |
| Acetylene glycol EO adduct (manufactured | 0.5 | parts |

| | |
|---|---|
| by Kawaken Fine Chemical Co., Ltd.) | |
| Ion-exchanged water | Balance |

### 3. Magenta Ink

### (1) Dispersion Preparation

First, an AB-type block polymer with an acid value of 300 and a number average molecular weight of 2500 was prepared by a usual method using benzyl acrylate and methacrylic acid as raw materials, and then neutralized with an aqueous solution of potassium hydroxide. The resultant was diluted with ion-exchanged water to prepare a homogeneous 50% by mass water-soluble resin fine particle dispersion.

Then, 100 g of the above polymer solution, 100 g of C.I. Pigment Red 122, and 800 g of ion-exchanged water were mixed and mechanically stirred for a predetermined time. After that, the mixture was centrifuged to remove undispersed substances including coarse particles, to obtain a magenta dispersion. In the obtained magenta dispersion, the pigment concentration was 10% by mass.

### (2) Ink Preparation

In the ink preparation, the above magenta dispersion was used and adjusted to a predetermined concentration with addition of the following ingredients thereto. These ingredients were thoroughly mixed and stirred, and then were filtered under pressure through a microfilter with a pore size of 2.5 μm (manufactured by FUJIFILM Corporation) to prepare a pigment ink with a pigment concentration of 3% by mass.

| | | |
|---|---|---|
| Above magenta dispersion | 30 | parts |
| Above water-soluble resin fine | 40 | parts |
| particle dispersion | | |
| Zonyl FSO-100 (fluorosurfactant | 0.05 | parts |
| manufactured by DuPont) | | |
| 2-Methyl-1,3-propanediol | 15 | parts |
| 2-pyrrolidone | 5 | parts |
| Acetylene glycol EO adduct (manufactured | 0.5 | parts |
| by Kawaken Fine Chemicals Co., Ltd.) | | |

| | |
|---|---|
| Ion-exchanged water | Balance |

### 4. Yellow Ink

### (1) Dispersion Preparation

First, the above anionic polymer P-1 was neutralized with an aqueous solution of potassium hydroxide, and the resultant was diluted with ion-exchanged water to prepare a homogeneous 10% by mass water-soluble resin fine particle dispersion.

Then, 300 g of the above polymer solution, 100 g of C.I. Pigment Yellow 74, and 600 g of ion-exchanged water were mixed and mechanically stirred for a predetermined time. After that, the mixture was centrifuged to remove undispersed substances including coarse particles, to obtain a yellow dispersion. In the obtained yellow dispersion, the pigment concentration was 10% by mass.

### (2) Ink Preparation

The following ingredients were mixed, thoroughly stirred to be dissolved and dispersed, and then were filtered under pressure through a microfilter with a pore size of 1.0 μm (manufactured by FUJIFILM Corporation) to prepare a pigment ink with a pigment concentration of 4% by mass.

| | | |
|---|---|---|
| Above yellow dispersion | 40 | parts |
| Above water-soluble resin fine | 40 | parts |
| particle dispersion | | |
| Zonyl FSO-100 (fluorosurfactant | 0.025 | parts |
| manufactured by DuPont) | | |
| 2-Methyl-1,3-propanediol | 15 | parts |
| 2-pyrrolidone | 5 | parts |
| Acetylene glycol EO adduct (manufactured | 1 | part |
| by Kawaken Fine Chemicals Co., Ltd.) | | |

| | |
|---|---|
| Ion-exchanged water | Balance |

### 5. Reactive Liquid

In the present embodiment, a reactive liquid was used which contains a reactive ingredient that reacts with the pigments contained in the inks, thereby causing flocculation or gelation of the pigments. Specifically, this reactive ingredient is an ingredient that can destroy the dispersion stability of an ink containing a pigment stably dispersed or dissolved in an aqueous medium through an action of ionic groups, in a case where the ingredient is mixed with the ink on a print medium P or the like. In the present embodiment, glutaric acid was used.

However, the glutaric acid does not necessarily have to be used. Any of various water-soluble organic acids and polyvalent metal salts may be used as the reactive ingredient in the reactive liquid. The content of the organic acid and the polyvalent metal salt based on the total mass of the composition contained in the reactive liquid is preferably 0.1% by mass or more and 90.0% by mass or less and more preferably 1.0% by mass or more and 70.0% by mass or less.

### (Reactive Liquid Preparation)

In the present embodiment, the glutaric acid (manufactured by FUJIFILM Wako Pure Chemical Corporation) was used as described above, and the following ingredients were mixed to prepare the reactive liquid.

| | | |
|---|---|---|
| Glutaric acid | 2 | parts |
| 2-pyrrolidone | 5 | parts |
| 2-Methyl-1,3-propanediol | 15 | parts |
| Acetylene glycol EO adduct (manufactured | 0.5 | parts |
| by Kawaken Fine Chemical Co., Ltd.) | | |

| | |
|---|---|
| Ion-exchanged water | Balance |

(6) Print Medium P (see FIG. 1 and others)

In the present embodiment, low-permeability print media P into which moisture hardly penetrates were used. A low-permeability print medium is a medium that has no moisture absorbency or absorbs only a very small amount of moisture. For this reason, if an aqueous ink containing no organic solvent is used, it is difficult to form an image because the ink is repelled. On the other hand, low-permeability print media are excellent in water resistance and weather resistance and therefore are suitable for outdoor usage. Usually, print media P with a water contact angle of 45° or more and preferably 60° or more at 25° C. are used.

As types of low-permeability print media, there are media each having a plastic layer formed on the top surface of a base material, media each having no ink-receptive layer formed on a base material, and sheets, films, banners, and the like made of glass, Yupo, plastic and the like. Examples of the plastic applied include polyvinyl chloride, polyethylene terephthalate, polycarbonate, polystyrene, polyurethane, polyethylene, polypropylene, and the like. These low-permeability print media are excellent in terms of water resistance, light resistance, and scratch resistance and therefore are generally used for printing of print products intended for outdoor exhibition.

As an example of a method for evaluating the permeability of a print medium P, the well-known Bristow method can be used. In the Bristow method, a predetermined amount of ink is first poured into a holding container with an opening slit in a predetermined size, and then the ink is brought into contact with a print medium P, which has been cut into a strip and wound around a wheel, through the slit. Then, the wheel is rotated while the position of the holding container is kept fixed, and the area (length) of the ink band transferred to the print medium P is measured. The ink transfer amount per unit area per second (ml·m−2) can be calculated from the area of this ink band. In the present embodiment, a print medium P having an ink transfer amount (water absorption amount) of less than 10 ml·m−2 at 30 msec½ according to the Bristow method is regarded as a low-permeability print medium. Accordingly, the print medium P may be a non-permeability print medium.

In the present embodiment, Scotchcal Graphic Film (IJ1220-10), an adhesive PVC film manufactured by 3M, was used as the low-permeability print medium.

### (7) Print Control

### (7-1) Waiting of Printing Operation

In the present embodiment, a fixing device (for example, the heater 203 (see FIG. 2)) was used to dry ink droplets ejected onto a print medium P, thereby fixing the inks to the print medium P. In normal printing operations, a time required for the print medium P to pass by the fixing device is shorter than a time required for the inks to dry in some cases. For this reason, in the present embodiment, in order to allocate an appropriate time for the print medium P to pass through an area which can receive the heating effect of the heater 203, a predetermined waiting time is provided between a certain scan of the liquid ejection head and the scan next to that scan.

Note that it is unnecessary to stop the liquid ejection head 205 (see FIG. 2) during the waiting time. The liquid ejection head 205 may be engaged in an operation such as moving, preliminary ejection, or wiping.

### (7-2) Problem in Waiting of Printing Operation

As described above, if a relatively long waiting time is provided, it is necessary to perform preliminary ejection of ink droplets as needed during the waiting to keep the nozzle surface 300 (see FIG. 3) from drying out. However, in the present embodiment, the maintenance mechanism 107 (see FIG. 1) is provided only on the HP side.

Hereinafter, the side equipped with the maintenance mechanism 107 will be called the HP side, whereas the side not equipped with the maintenance mechanism 107 will be called the BP side. In addition, a scan from the HP side to the BP side (scan in the −X direction) will be called a “forward scan”, whereas a scan from the BP side to the HP side (scan in the +X direction) will be called a “backward scan”.

In this case, a desirable waiting time can be provided on the HP side because the preliminary ejection is possible. In contrast, if a desirable waiting time is provided on the BP side, the nozzle surface 300 (see FIG. 3) may dry out, which may cause ejection failure and affect the image quality. To prevent this, on the BP side, it is necessary to provide a waiting time within a range in which the nozzle surface 300 will not dry out.

As described above, in the present embodiment, the waiting time is provided in order to fix (dry) the inks by using the fixing device. In this connection, the waiting time required to fix the inks varies depending on the ink drying efficiency. Therefore, unless a sufficient waiting time is provided on the BP side, the inks may be fixed insufficiently and affect the scratch resistance or the like of the finished printed product.

Another conceivable method is to cause the liquid ejection head 205 to wait only on the HP side. However, in this method, a difference between the waiting time on the HP side and the waiting time on the BP side is so large that time difference unevenness may occur.

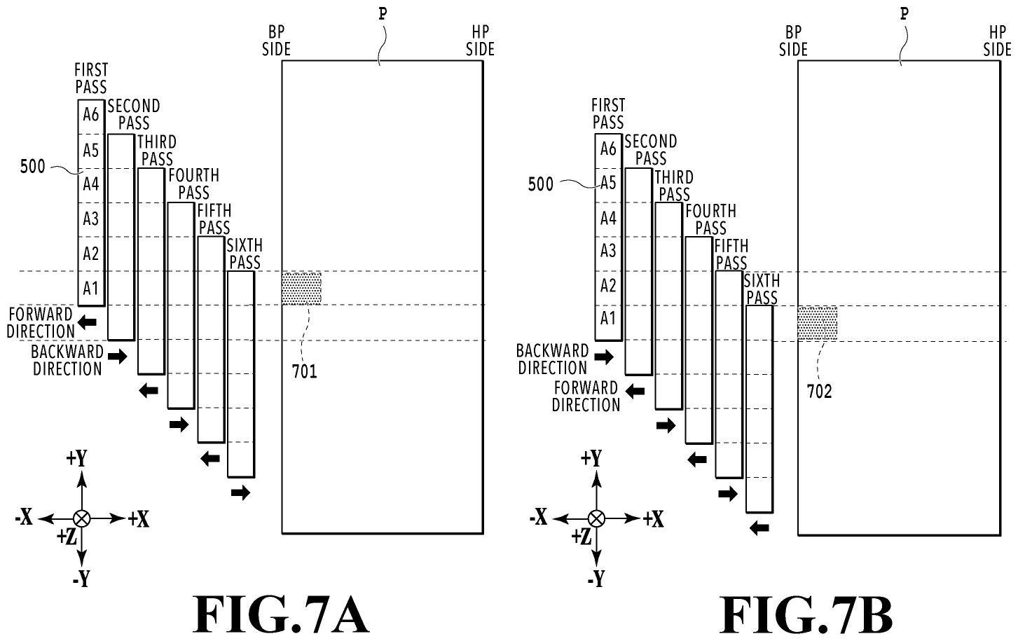

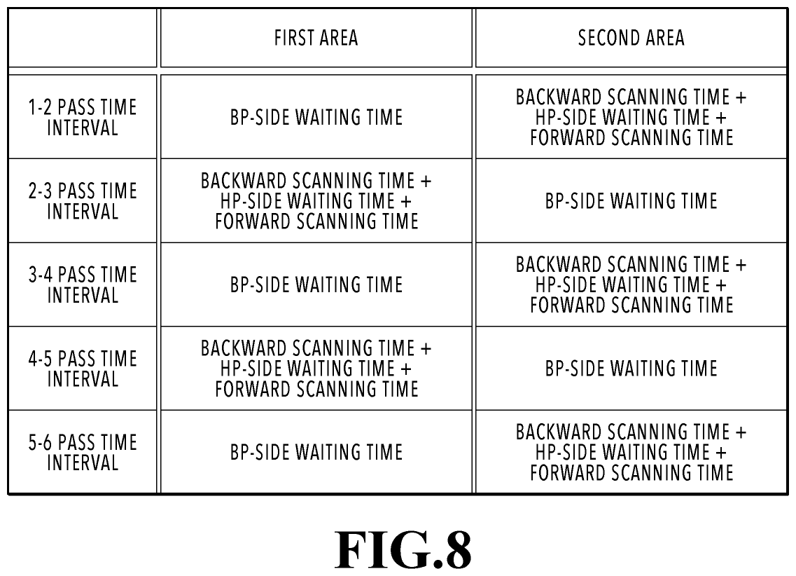

Here, using FIGS. 7A, 7B, and 8, the time difference unevenness will be described. The time difference unevenness is a phenomenon in which areas with the first pass performed with the forward scan and areas with the first pass performed with the backward scan during execution of the aforementioned multipass printing differ from each other in color development and gloss, which appear as unevenness. Here, the time difference unevenness tends to be noticeable in particular around the BP-side end and the HP-side end of a print medium P.

FIGS. 7A and 7B are explanatory diagrams for time difference unevenness.

FIG. 7A is a schematic diagram of printing operations on a first area 701 at which the first pass is performed with the forward scan. FIG. 7A illustrates, as the first area 701, a printed area on the BP side where the time difference unevenness tends to be noticeable.

In the first area 701, printing in the first pass is performed with the forward scan, the liquid ejection head 205 turns back at the BP-side end, and printing in the second pass is performed with the backward scan. In short, in the first area 701, the second pass with the backward scan is performed relatively immediately after the first pass with the forward scan. After that, the liquid ejection head 205 turns back at the HP-side end and then printing in the third pass is performed again with the forward scan. In short, in the first area 701, after the second pass with the backward scan, a relatively long period of time passes, and then the third pass with the forward scan is performed. After that, the forward scan and the backward scan are alternately repeated.

FIG. 7B is a schematic diagram of printing operations on a second area 702 at which the first pass is performed with the backward scan.

The second area 702 is adjacent to the first area 701 and located downstream of the first area 701 (see FIG. 7A) in the convenience direction (−Y direction). In the second area 702, after the first pass with the backward scan, a relatively long period of time passes, and then the second pass with the forward scan is performed. In addition, the third pass with the backward scan is performed relatively immediately after the second pass with the forward scan.

FIG. 8 is a table indicating time intervals between passes in multipass printing for the first area 701 (see FIG. 7A) and time intervals between passes in the multipass printing for the second area 702 (see FIG. 7B).

First, description will be given of a “1-2 pass time interval” in the first area 701 (a time interval from the end of the first forward scan to the start of the first backward scan. Regarding the 1-2 pass time interval in the first area 701, immediately after the end of the printing in the first pass except for a BP-side waiting time, the liquid ejection head 205 can turn back and start the printing in the second pass. Therefore, the 1-2 pass time interval in the first area 701 is substantially only the BP-side waiting time.

Next, regarding the subsequent 2-3 pass time interval, after the printing in the second pass, the liquid ejection head 205 performs the backward scan up to the HP side, waits on the HP side, performs the forward scan to come back to the BP side, and then performs the printing in the third pass. Accordingly, the “2-3 pass time interval” is equal to “backward scanning time+HP-side waiting time+forward scanning time”. The printing operations as described above are alternately performed between the following passes, resulting in the pass time intervals as specified in FIG. 8.

Next, the second area 702 (see FIG. 7B) is considered.

As illustrated in FIG. 7B, the second area 702 is adjacent to the first area 701 (see FIG. 7A), and has a length in the Y direction corresponding to each of the nozzle groups A1 to A6. In the second area 702, printing in the first pass is performed with the backward scan and printing in the second pass is performed with the forward scan. In the third and subsequent passes, the forward scan and the backward scan are alternately performed in the same manner as in the first area 701.

The pass time intervals in this case are presented in a column named “Second Area” in FIG. 8.

As illustrated in FIGS. 7A and 7B, the scanning directions in the passes on the second area 702 (see FIG. 7B) are reverse to those in the first area 701 (see FIG. 7A). Accordingly, as presented in FIG. 8, the pass time intervals are also reversed. In the second area 702 (see FIG. 7B), the “1-2 pass time interval” is equal to “backward scanning time+HP-side waiting time+forward scanning time” and the 2-3 pass time interval is only the BP-side waiting time. Also between the following passes, the forward scan and the backward scan are alternately performed on the second area 702.

Next, the reason why the above difference in pass time interval affects the image quality will be described. In each pass, at a time when an ink droplet is applied to a print medium P, the ink droplet may interact with an ink droplet already applied to the print medium P before that time. It is known that how this interaction occurs varies depending on the penetration and drying states of the ink droplet already applied. The penetration and the drying states of the ink droplet are affected by the pass time interval. Accordingly, the interaction between the ink droplets is affected by how long each pass time interval is. This varies the final fixing state of the ink droplets and therefore affects the image quality such as color development and gloss. The first and second areas, in which the long and short lengths of the pass time intervals are in the reverse relationship, are arranged alternately in the Y direction, and are visually recognized as time difference unevenness. Although the time difference unevenness is explained focusing on the BP side, the same as on the BP side occurs on the HP side except that the long and short lengths of the pass time intervals are reversed. On the other hand, the time difference unevenness is less noticeable at a center area where the pass time intervals are substantially equalized.

Based on the above description, description will be given of the reason why the time difference unevenness increases if the waiting time required for drying is provided only on the HP side. In the case where the waiting time is provided only on the HP side (in other words, the BP-side waiting time is set to zero), the HP-side waiting time has to be twice longer than in the case where the BP-side waiting time is also provided. In this case, in the first area 701 with the first pass performed with the forward scan, the “1-2 pass time interval” is composed of only the BP-side waiting time and accordingly is almost zero.

On the other hand, the “2-3 pass time interval” has a larger value because the “2-3 pass time interval” is composed of the doubled HP-side waiting time in addition to the forward and backward scanning times. As presented in the column named “First Area” in FIG. 8, such printing operations are alternately repeated between the following passes.

Next, in the second area 702 with the first pass performed with the backward scan, the “1-2 pass time interval” has a larger value and the “2-3 pass time interval” is almost zero, in contrast to the first area 701.

As presented in the column named “Second Area” in FIG. 8, such printing operations are alternately repeated between the following passes.

Here, the image quality is affected by how long each pass time interval is as described above. The larger a difference in the pass time interval between the first area 701 with the forward scan performed in the first pass and the second area 702 with the backward scan performed in the first pass, the larger a difference in the image quality such as color development and gloss between these areas and accordingly the greater the time difference unevenness. To address this, in the present embodiment, the HP-side waiting time and the BP-side waiting time are set such that a waiting time that can produce an appropriate fixing effect is provided while the difference in the pass time interval between the areas is kept small enough to make time difference unevenness unnoticeable.

### (7-3) Control of Waiting Times

FIG. 9 is a diagram illustrating an example of a table that can be stored in the memory 405 (see FIG. 4) in the present embodiment. In FIG. 9, (s) denotes (seconds).

As presented in FIG. 9, a column named “Required Waiting Time(s)” presents a time for which the carriage unit 101 should wait on the HP side or the BP side in order to fix the inks applied on the print medium P (see FIG. 1). A column named “HP-Side Waiting Time(s)” presents a HP-side waiting time out of the above “Required Waiting Time”. A column named “BP-Side Waiting Time(s)” presents a BP-side waiting time out of the above “Required Waiting Time”. In other words, the column “Required Waiting Time(s)” presents the total waiting time that is the sum of the HP-side waiting time and the BP-side waiting time.

The more difficult it is for the inks to penetrate a print medium P, the longer the waiting time is required. For example, if a medium that is difficult for the inks to penetrate is used as the print medium P, a relatively long waiting time is required. In addition to this, if the ambient temperature is low or if the ambient humidity is high, a relatively long waiting time is also required. The value of “Required Waiting Time” is set to an appropriate value depending on conditions such as a type of print medium, an ambient temperature, and an ambient humidity. In other words, it is preferable to prepare a table as presented in FIG. 9 for each combination of conditions including a type of print medium, an ambient temperature, an ambient humidity, and others.

On the other hand, it is preferable that the HP-side waiting time and the BP-side waiting time be as equal as possible from the viewpoint of the time difference unevenness as described above. Therefore, in the present embodiment, if the waiting time required to fix the inks applied to the print medium P is within such a range that the drying state of the nozzle surface 300 is tolerable, the HP-side waiting time and the BP-side waiting time are set to be equal to each other.

For example, if the waiting time required to fix the inks applied to the print medium P is 4.0 seconds or shorter, the HP-side waiting time is set to 2.0 seconds and the BP-side waiting time is set to 2.0 seconds so as to be equal to the HP-side waiting time.

However, if the liquid ejection head 205 (see FIG. 2) waits for a long time on the BP side not equipped with the maintenance mechanism 107 (see FIG. 1 and others), the nozzle surface 300 (see FIG. 3) may dry out. For this reason, the BP-side waiting time is set to no longer than 2.0 seconds.

Therefore, the CPU 401 (see FIG. 4) in the present embodiment causes the liquid ejection head to wait for a first waiting time at a first waiting position after the end of the backward scan and before the start of the forward scan of the liquid ejection head. Then, the CPU 401 causes the liquid ejection head to wait for a second waiting time at a second waiting position after the end of the forward scan and before the start of the backward scan of the liquid ejection head. If the first waiting time is equal to or less than a predetermined value, the first waiting time and the second waiting time are set to be equal to each other. On the other hand, if the first waiting time exceeds the predetermined value, the second waiting time is fixed to the predetermined value, while the first waiting time is set to be longer than the second waiting time.

For example, if the above “Required Waiting Time(s)” exceeds 4.0 seconds, the BP-side waiting time is fixed to 2.0 seconds. Then, the HP-side waiting time is set to a time obtained by subtracting 2.0 seconds, which is the fixed BP-side waiting time, from the “Required Waiting Time(s)”.

The time difference unevenness is known to become more noticeable as the time interval between successive scans on a unit area as explained in FIG. 8 varies more greatly between the areas (between the first and second areas). Such variation in time interval tends to be rather less noticeable in a printing mode with a large number of multipasses or in a printing mode with sufficiently long waiting times. In other words, the time difference unevenness becomes more noticeable as the “Required Waiting Time(s)” becomes shorter, and becomes less noticeable as the “Required Waiting Time(s)” becomes longer. For this reason, in the present embodiment, if the “Required Waiting Time(s)” is 4.0 seconds or shorter, reducing the time difference unevenness is prioritized over keeping the nozzle surface from drying out and the HP-side and BP-side waiting times are set to an equal value. On the other hand, if the “Required Waiting Time(s)” exceeds 4.0 seconds, keeping the nozzle surface from drying out is prioritized over reducing the time difference unevenness and waiting for longer than 2.0 seconds is set on the HP side provided with the cap.

In this way, according to the present embodiment, the HP-side waiting time and the BP-side waiting time are appropriately controlled, so that an appropriate fixing time long enough to make time difference unevenness unnoticeable can be achieved while the nozzle surface is kept from drying out.

As described above, in the present embodiment, if the waiting time required to fix the inks to the print medium P is equal to or shorter than the predetermined value, the waiting time required to fix the inks to the print medium P is divided into two equal parts for the HP side and the BP side. If the waiting time required to fix the inks to the print medium P exceeds the predetermined value, the BP-side waiting time is fixed to the time shorter than the HP-side waiting time. In this case, the HP-side waiting time is set to the value obtained by subtracting the BP-side waiting time, which is fixed to the predetermined time, from the waiting time required to fix the inks to the print medium P.

With this configuration, even if a relatively long waiting time is required to fix the inks to the print medium P, the liquid ejection head will not wait for a long time on the BP side. The liquid ejection head waits for a relatively short time on the BP side and waits for a long time on the HP side equipped with the maintenance mechanism.

Thus, according to the liquid ejection apparatus in the present embodiment, the liquid fixing time can be allocated, while the nozzle surface is kept from drying out.

### Variation of First Embodiment

The first embodiment presents the example where the table as presented in FIG. 9 is prepared and stored in the memory 405 of the apparatus in advance. However, the HP-side waiting time and the BP-side waiting time may be set by the CPU 401 depending on conditions varying from time to time.

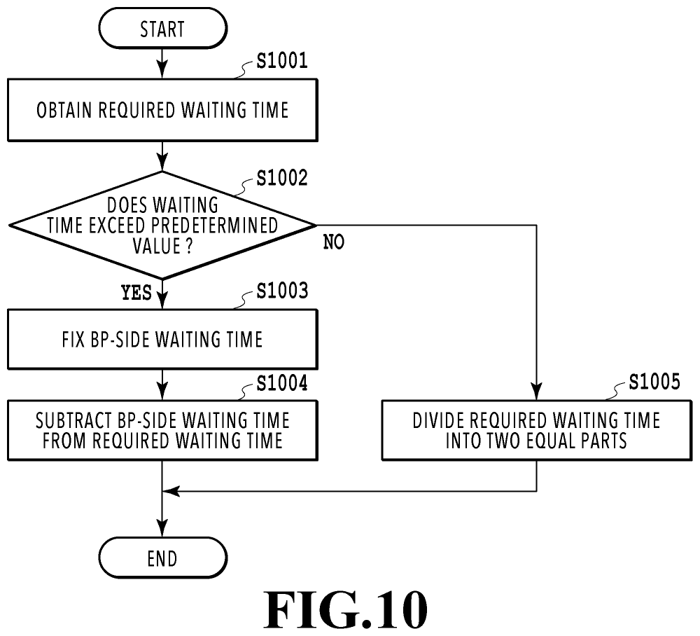

FIG. 10 is a flowchart presenting processes for setting the HP-side waiting time and the BP-side waiting time in the present variation. A series of processes presented in FIG. 10 is performed by the CPU 401 (see FIG. 4) loading program codes stored in the ROM 402 (see FIG. 4) into the RAM 403 (see FIG. 4) and executing the loaded program codes. In description of each process, sign “S” indicates a step in this flowchart.

In S1001, the CPU 401 obtains a waiting time required to fix the inks to a print medium P as a print target. In S1001, the CPU 401 may additionally obtain information other than the above. For example, the CPU 401 may refer to a table, stored in the memory 405 (see FIG. 4), in which types of print media P are associated with drying times of the print media P, and obtain the time required to fix the inks to the print medium P. Here, the type of print medium P as the print target may be inputted by a user via the input/output port 404 or may be obtained by a sensor provided to the apparatus. After completing the process in S1001, the CPU 401 performs a process in S1002.

In S1002, the CPU 401 determines whether or not the waiting time required to fix the inks to the print medium P exceeds a predetermined value (for example, 4.0 seconds). If the waiting time required to fix the inks to the print medium P exceeds the predetermined value, the CPU 401 performs a process in S1003 (YES in S1002). If the waiting time required to fix the inks to the print medium P is equal to or less than the predetermined value, the CPU 401 performs a process in S1005 (NO in S1002).

In S1003, the CPU 401 fixes the BP-side waiting time (for example, 2.0 seconds). After completing the process in S1003, the CPU 401 performs a process in S1004.

In S1004, the CPU 401 sets the HP-side waiting time to the value obtained by subtracting the BP-side waiting time from the waiting time required to fix the inks to the print medium P (for example, 5.0 seconds−2.0 seconds=3.0 seconds). After completing the process in S1004, the CPU 401 ends the setting of the HP-side waiting time and the setting of the BP-side waiting time.

In S1005, the CPU 401 divides the waiting time required to fix the inks to the print medium P into two equal parts, and sets the HP-side waiting time and the BP-side waiting time to the equal value (for example, 4.0 seconds/2=2.0 seconds). In this way, the time difference unevenness can be reduced as much as possible. After completing the process in S1005, the CPU 401 ends the setting of the HP-side waiting time and the setting of the BP-side waiting time.

Here, the HP-side waiting time and the BP-side waiting time do not necessarily have to be an equal value. There may be a slight difference in waiting time between the HP side and the BP side due to a structural difference and so on. Even if such a slight difference does occur, the difference is not a problem as long as the time difference unevenness can be kept unnoticeable. In other words, in the case where the time required to fix the inks to the print medium P does not exceed the predetermined value, the HP-side waiting time and the BP-side waiting time may have a difference smaller than in the case where the required time exceeds the predetermined value.

As described above, in the present variation, if the waiting time required to fix the inks to the print medium P exceeds the predetermined value, the BP-side waiting time is fixed to the time shorter than the HP-side waiting time. Then, a shortage of the waiting time due to the fixing of the BP-side waiting time is added to the HP-side waiting time.

Thus, also according to the liquid ejection apparatus in the present variation, the liquid fixing time can be allocated while the nozzle surface is kept from drying out.

### Second Embodiment

The present embodiment has an object to provide a liquid ejection apparatus capable of more flexibly setting the HP-side waiting time and the BP-side waiting time depending on the length of a scanning time. In the following description, different points from those in the first embodiment will be mainly described while the constituents same as or corresponding to those in the first embodiment will be denoted with the same reference signs, and description thereof will be omitted.

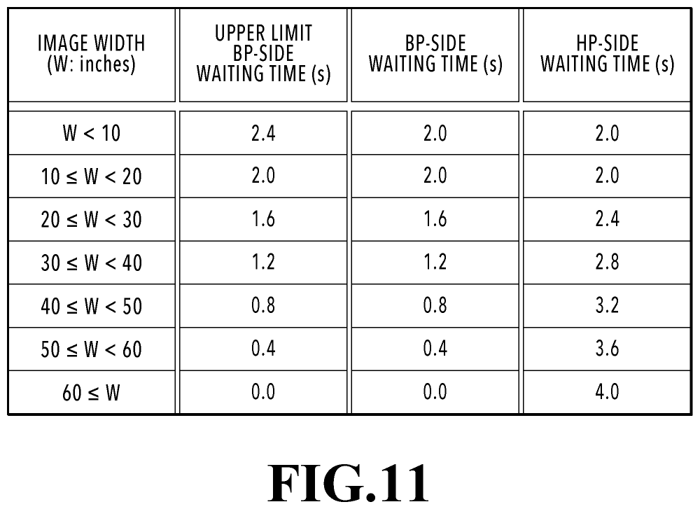

FIG. 11 is a diagram illustrating an example of a table applicable to the present embodiment.

In the present embodiment, the upper limit of the BP-side waiting time is set according to a scanning time of the liquid ejection head 205 (see FIG. 2). The upper limit of the BP-side waiting time is set to be smaller as the scanning time becomes longer. This is because the longer the scanning time, the more the nozzle surface dries out during scanning, so it is necessary to reduce the waiting time on the BP side where the preliminary ejection is not possible. For this reason, the BP-side waiting time is set to a value equal to or less than this upper limit. Then, the HP-side waiting time is set to the value obtained by subtracting the BP-side waiting time from the waiting time required to fix the inks to the print medium P.

In general, the scanning time changes depending on the width of a print medium, the width of an image, a set printing mode, and so on. The present embodiment will be described in a case where the scanning time is adjusted appropriately according to the width of an image.

FIG. 11 is the diagram illustrating an example of a table in which the width of an image “Image Width (inches)”, the upper limit of the BP-side waiting time “Upper Limit BP-side Waiting Time(s)”, “BP-side Waiting Time(s)”, and “HP-side Waiting Time(s)” are stored in association with each other. This table presents the case where the waiting time required to fix the inks to the print medium P is 4.0 seconds as an example.

For example, the upper limit of the BP-side waiting time is set to 1.6 seconds for the case where the width of an image to be formed is 20 inches or larger and smaller than 30 inches. From the viewpoint of the time difference unevenness, it is preferable that the HP-side waiting time and the BP-side waiting time be equal to each other. According to this requirement, if the waiting time required to fix the inks to the print medium P is 4.0 seconds, the BP-side waiting time will be set to 2.0 seconds, which, however, exceeds the upper limit. For this reason, the BP-side waiting time is set to 1.6 seconds, which is the upper limit. Then, the HP-side waiting time is set to 2.4 seconds obtained by subtracting 1.6 seconds, which is the BP-side waiting time, from 4.0 seconds, which is the waiting time required to fix the inks to the print medium P.

On the other hand, if the half of the waiting time required to fix the inks to the print medium P is less than the upper limit of the BP-side waiting time, the HP-side waiting time and the BP-side waiting time are set to the half value of the waiting time required to fix the inks to the print medium P.

For example, if the width of an image to be formed from now on is smaller than 10 inches, the upper limit of the BP-side waiting time is set to 2.4 seconds. If the waiting time required to fix the inks to the print medium P is 4.0 seconds, 2.0 seconds, which is the half of that value, does not exceed the upper limit, 2.4 seconds. Accordingly, the BP-side waiting time and the HP-side waiting time are set to 2.0 seconds, which is the half of 4.0 seconds.

This configuration sets the HP-side waiting time and the BP-side waiting time to appropriate values according to the scanning time and thereby makes it possible to achieve an appropriate fixing time long enough to make time difference unevenness unnoticeable while keeping the nozzle surface from drying out. Here, in a case where the scanning time is relatively short, the HP-side waiting time and the BP-side waiting time do not necessarily have to be set to an equal value as long as the waiting time required to fix the inks to the print medium P can be allocated while the BP-side waiting time is kept within the upper limit. In other words, the HP-side waiting time and the BP-side waiting time may differ slightly as long as the time difference unevenness can be kept unnoticeable.

As described above, in order to allocate the waiting time required to fix the inks to the print medium, the liquid ejection apparatus in the present embodiment sets the waiting time on the HP side, where the preliminary ejection is possible, to a larger value than a value for the waiting time on the BP side where the preliminary ejection is not possible. The appropriate control of the HP-side and BP-side waiting times based on the scanning time makes it possible to achieve an appropriate fixing time long enough to make the time difference unevenness unnoticeable while keeping the nozzle surface from drying out.

Thus, according to the liquid ejection apparatus in the present embodiment, the liquid fixing time can be allocated while the nozzle surface is kept from drying out. In addition, the HP-side waiting time and the BP-side waiting time can be set more flexibly according to the length of the scanning time.

Also in the present embodiment, it is not essential to prepare the table as presented in FIG. 11. As described by using FIG. 10 in the first embodiment, the CPU 401 may determine the waiting times based on various conditions.

### Third Embodiment

The present embodiment has an object to provide a liquid ejection apparatus capable of more flexibly setting the HP-side waiting time and the BP-side waiting time according to how easily the nozzle surface dries out. Also in the following description, different points from those in the first and second embodiments will be mainly described while the constituents same as or corresponding to those in the first and second embodiments will be denoted with the same reference signs, and description thereof will be omitted.

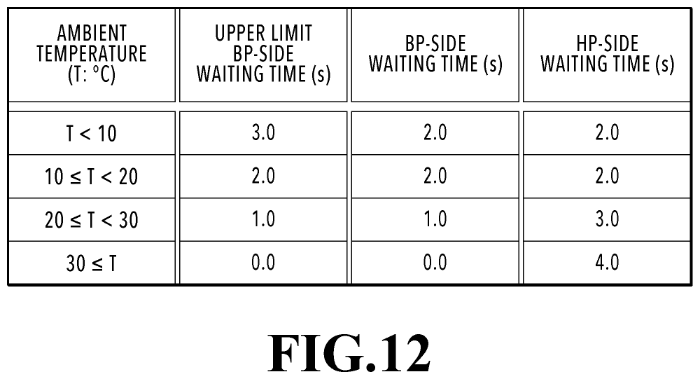

FIG. 12 is a diagram illustrating an example of a table applicable to the present embodiment.

In the second embodiment, the upper limit value of the BP-side waiting time is set according to the length of the scanning time. In contrast, in the present embodiment, the upper limit value of the BP-side waiting time is set according to a surrounding environment.

In the present embodiment, as presented in FIG. 12, the upper limit of the BP-side waiting time set according to how easily the nozzle surface 300 (see FIG. 3) dries out is provided. In the present embodiment, the upper limit of the BP-side waiting time is set to be smaller as the environment becomes more prone to dry the nozzle surface. This is because the more easily the nozzle surface dries out, the more it is necessary to reduce the waiting time on the BP side, where the preliminary ejection is not possible. In the present embodiment, a case where an ambient temperature around a location where the liquid ejection apparatus 100 (see FIG. 1) is installed is high will be described as an example of the case where the nozzle surface easily dries out. However, an example where the nozzle surface easily dries out is not limited to the case where the ambient temperature is high. For example, the lower the ambient humidity, the more easily the nozzle surface dries out.

For example, if the ambient temperature is 20° C. or higher and lower than 30° C., the upper limit of the BP-side waiting time is set to 1.0 second. Here, if the waiting time required to fix the inks to the print medium P is 4.0 seconds, it is preferable to set the HP-side waiting time and the BP-side waiting time to 2.0 seconds from the viewpoint of the time difference unevenness. However, in this case, the BP-side waiting time exceeds the upper limit. For this reason, the BP-side waiting time is set to 1.0 second, which is the upper limit. Then, the HP-side waiting time is set to 3.0 seconds obtained by subtracting 1.0 second, which is the BP-side waiting time, from 4.0 seconds.

On the other hand, if the half of the waiting time required to fix the inks to the print medium P is less than the upper limit of the BP-side waiting time, the HP-side waiting time and the BP-side waiting time are set to equal to each other.

For example, the ambient temperature is lower than 10° C., the upper limit of the BP-side waiting time is set to 3.0 seconds. Then, if the waiting time required to fix the inks to the print medium P is 4.0 seconds, 2.0 seconds, which is the half of that value, does not exceed 3.0 seconds, which is the upper limit. Accordingly, the BP-side waiting time and the HP-side waiting time are set to 2.0 seconds, which is the half of 4.0 seconds.

This configuration sets the HP-side waiting time and the BP-side waiting time to appropriate values according to the surrounding environment and thereby makes it possible to achieve an appropriate fixing time long enough to make time difference unevenness unnoticeable while keeping the nozzle surface from drying out. Here, the HP-side waiting time and the BP-side waiting time may differ slightly as long as the time difference unevenness can be kept unnoticeable.

As described above, in order to allocate the waiting time required to fix the inks to the print medium, the liquid ejection apparatus in the present embodiment sets the waiting time on the HP side, where the preliminary ejection is possible, to a larger value than a value for the waiting time on the BP side, where the preliminary ejection is not possible. The appropriate control of the HP-side and BP-side waiting times based on the surrounding environment makes it possible to achieve an appropriate fixing time long enough to make time difference unevenness unnoticeable while keeping the nozzle surface from drying out.

Thus, according to the liquid ejection apparatus in the present embodiment, the liquid fixing time can be allocated while the nozzle surface is kept from drying out. In addition, the HP-side waiting time and the BP-side waiting time can be set more flexibly according to how easily the nozzle surface dries out.

### Other Embodiment

In the first to third embodiments, the inkjet printing apparatus and the printing method using the inkjet printing apparatus are described. However, the technique disclosed herein may be applied to an image processing apparatus and an image processing method for generating data for carrying out any of the printing methods described in the first to third embodiments.

In addition, the technique disclosed herein may be applied to a mode where a program for carrying out any of the printing methods described in the first to third embodiments is prepared in an apparatus separate from the liquid ejection apparatus.

The technique disclosed herein may be effectively applied to various liquid ejection apparatuses including not only thermal-jet type inkjet printing apparatuses but also, for example, so-called piezo-type inkjet printing apparatuses to eject the inks using the piezoelectric elements.

In the first to third embodiments, the difference between the HP-side waiting time and the BP-side waiting time is considered as a factor causing the time difference unevenness. However, in addition to the difference between the HP-side waiting time and the BP-side waiting time, factors such as a type of print medium, a distance from the print surface of the print medium to the nozzle surface of the liquid ejection head, the color of an image, and the amounts of inks ejected may affect how noticeable the time difference unevenness is. For this reason, with these factors taken into consideration, the upper limit of the BP-side waiting time may be changed so as to allocate the liquid fixing time, keep the nozzle surface from drying out, and reduce the time difference unevenness.

In the above embodiments, the mode is described in which an appropriate waiting time is provided between scans in order to allocate a time for the print medium P to pass through the area that can receive the heating effect of the heater 203. However, the heater 203 is not an essential requirement in the present disclosure. Even in a printing apparatus not equipped with a fixing device to promote ink fixing, it may be necessary to provide an appropriate waiting time between scans in multipass printing in order to obtain a high-quality image. In other words, regardless of whether or not the heater 203 is equipped, the appropriate control of the HP-side waiting time and the BP-side waiting time makes it possible to allocate an appropriate fixing time long enough to make time difference unevenness unnoticeable while keeping the nozzle surface from drying out.

In the second embodiment, the required time for one scan by the liquid ejection head is obtained based on the width of an image in the scanning direction. Instead, the required time for one scan by the liquid ejection head may be obtained based on the scanning speed of the liquid ejection head. For example, the required time for one scan may be obtained based on the scanning distance of the carriage based on the width of a print medium or an image and the carriage speed according to the printing mode, and the “Upper Limit BP-side Waiting Time(s)” may be set to a larger value as the required time becomes shorter.

According to the liquid ejection apparatus in the present disclosure, it is possible to allocate a liquid fixing time.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-098191, filed Jun. 18, 2024 which are hereby incorporated by reference herein in its entirety.

What is claimed is:

1. A liquid ejection apparatus comprising:
a scanning unit configured to cause a liquid ejection head to perform forward and backward scans in a scanning direction, the liquid ejection head configured to perform an ejection operation by ejecting a liquid;
a conveyance unit configured to convey a print medium in a conveyance direction crossing the scanning direction; and
a control unit configured to cause the scanning unit to wait for a first waiting time at a first waiting position after the end of a backward scan and before the start of a forward scan of the scanning unit, and cause the scanning unit to wait for a second waiting time at a second waiting position after the end of a forward scan and before the start of a backward scan of the scanning unit, wherein
the control unit performs control to set the second waiting time to a first value in a case where the first waiting time is the first value, and set the second waiting time to be shorter than the first waiting time in a case where the first waiting time is a second value that is larger than the first value.

2. The liquid ejection apparatus according to claim 1, wherein in the case where the first waiting time is the second value, the control unit performs control to set the second waiting time to a predetermined value.

3. The liquid ejection apparatus according to claim 1, wherein
the control unit
obtains a total waiting time of the first waiting time and the second waiting time, the total waiting time being to be required to fix the liquid ejected onto the print medium,
in a case where a half value of the total waiting time is equal to the first value, sets the first waiting time and the second waiting time to the half value of the total waiting time, and
in a case where the half value of the total waiting time is equal to the second value, sets the first waiting time to be longer than the second waiting time.

4. The liquid ejection apparatus according to claim 3, further comprising a drying unit configured to dry the print medium, wherein
the drying unit is provided downstream of the liquid ejection head in the conveyance direction, and
the total waiting time is a time required for the drying unit to dry the liquid ejected onto the print medium by the liquid ejection head.

5. The liquid ejection apparatus according to claim 1, wherein
in the scanning direction, the first waiting position is a position where a maintenance mechanism configured to receive the liquid preliminarily ejected by the liquid ejection head is installed.

6. The liquid ejection apparatus according to claim 3, further comprising a storage unit configured to store a table in which the first waiting time, the second waiting time, and the total waiting time are associated with each other, wherein
the control unit sets the first waiting time and the second waiting time by referring to the table.

7. The liquid ejection apparatus according to claim 1, wherein
the control unit
obtains a total waiting time of the first waiting time and the second waiting time, the total waiting time being to be required to fix the liquid ejected onto the print medium,
sets an upper limit value of the second waiting time such that the upper limit value becomes smaller as a required time for one scan by the liquid ejection head becomes shorter, and
in a case where a half value of the total waiting time exceeds the upper limit value, sets the first waiting time and the second waiting time such that the second waiting time is the upper limit value and the first waiting time is a value obtained by subtracting the upper limit value from the total waiting time.

8. The liquid ejection apparatus according to claim 7, wherein the control unit obtains the required time based on a width in the scanning direction of an image to be printed by the liquid ejection head.

9. The liquid ejection apparatus according to claim 7, wherein the control unit obtains the required time based on a width in the scanning direction of a print medium to be printed by the liquid ejection head.

10. The liquid ejection apparatus according to claim 9, wherein the control unit obtains the required time based on a scanning speed of the scanning unit.

11. The liquid ejection apparatus according to claim 1, wherein
the control unit
obtains a total waiting time of the first waiting time and the second waiting time, the total waiting time being to be required to fix the liquid ejected onto the print medium,
sets an upper limit value of the second waiting time such that the upper limit value becomes smaller as an environment becomes more prone to dry a nozzle surface of the liquid ejection head, and
in a case where a half value of the total waiting time exceeds the upper limit value, sets the first waiting time and the second waiting time such that the second waiting time is the upper limit value and the first waiting time is longer than the second waiting time.

12. The liquid ejection apparatus according to claim 11, wherein the control unit sets the upper limit value of the second waiting time such that the upper limit value becomes smaller as an ambient temperature becomes higher.

13. The liquid ejection apparatus according to claim 11, wherein the control unit sets the upper limit value of the second waiting time such that the upper limit value becomes smaller as an ambient humidity becomes lower.

14. The liquid ejection apparatus according to claim 1, wherein the liquid is an ink or a reaction liquid that is reactive with the ink.

15. A control method of controlling a liquid ejection apparatus including a scanning unit configured to cause a liquid ejection head to perform forward and backward scans in a scanning direction, the liquid ejection head configured to perform an ejection operation by ejecting a liquid, and a conveyance unit configured to convey a print medium in a conveyance direction crossing the scanning direction, the method comprising the steps of:
causing the scanning unit to wait for a first waiting time at a first waiting position after the end of a backward scan and before the start of a forward scan of the scanning unit; and
causing the scanning unit to wait for a second waiting time at a second waiting position after the end of a forward scan and before the start of a backward scan of the scanning unit, wherein
in a case where the first waiting time is a first value, the second waiting time is set to the first value, and
in a case where the first waiting time is a second value that is larger than the first value, the second waiting time is set to be shorter than the first waiting time.

16. The control method according to claim 15, wherein in the case the first waiting time is the second value, the second waiting time is set to a predetermined value.
